(19) United States
(12) Patent Application Publication
(10) Pub. No.: US 2008/0076366 A1
(43) Pub. Date: Mar. 27, 2008

(54) Multiple band antenna structure

(75) Inventor: Ahmadreza Reza Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/527,959

(22) Filed: Sep. 27, 2006

(51) Int. Cl. H04B 1/18

(52) U.S. Cl. 455/168.1; 455/121

(57) ABSTRACT

A multiple band antenna structure includes a plurality of antenna sections and a coupling circuit. The coupling circuit is operable in a first mode to couple the plurality of antenna sections into a first antenna structure for transceiving radio frequency signals within a first radio frequency band and is operable in a second mode to couple the plurality of antenna sections into a second antenna structure for transceiving radio frequency signals within a second radio frequency band, where each of the plurality of antenna sections is tuned to a corresponding frequency band.

### CROSS REFERENCE TO RELATED PATENTS

NOT APPLICABLE

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to wireless communication systems and more particularly to antennas used within such systems.

2. Description of Related Art

Communication systems are known to support wireless and wire lined communications between wireless and/or wire lined communication devices. Such communication systems range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, RFID, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to the antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is also known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

Since the wireless part of a wireless communication begins and ends with the antenna, a properly designed antenna structure is an important component of wireless communication devices. As is known, the antenna structure is designed to have a desired impedance (e.g., 50 Ohms) at an operating frequency, a desired bandwidth centered at the desired operating frequency, and a desired length (e.g., ¼ wavelength of the operating frequency for a monopole antenna). As is further known, the antenna structure may include a single monopole or dipole antenna, a diversity antenna structure, the same polarization, different polarization, and/or any number of other electro-magnetic properties.

One popular antenna structure for RF transceivers is a three-dimensional in-air helix antenna, which resembles an expanded spring. The in-air helix antenna provides a magnetic omni-directional mono pole antenna, but occupies a significant amount of space and its three dimensional aspects cannot be implemented on a planer substrate, such as a printed circuit board (PCB).

For PCB implemented antennas, the antenna has a meandering pattern on one surface of the PCB. Such an antenna consumes a relatively large area of the PCB. For example, a ¼ wavelength antenna at 900 MHz has a total length of approximately 8 centimeters (i.e., 0.25*32 cm, which is the approximate wavelength of a 900 MHz signal). As another example, a ¼ wavelength antenna at 2400 MHz has a total length of approximately 3 cm (i.e., 0.25*12.5 cm, which is the approximate wavelength of a 2400 MH signal). Even with a tight meandering pattern, a single 900 MHz antenna consumes approximately 4 cm². If the RF transceiver is a multiple band transceiver (e.g., 900 MHz and 2400 MHz), then two antennas are needed, which consumes even more PCB space. With a never-ending push for smaller form factors with increased performance (e.g., multiple frequency band operation), a current antenna structures are not practical for many newer wireless communication applications.

Therefore, a need exists for a multiple frequency band antenna structure without the above mentioned limitations.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of a wireless communication system in accordance with the present invention;

FIG. 2 is a schematic block diagram of a radio frequency identification (RFID) system in accordance with the present invention;

FIG. 3 is a schematic block diagram of a radio frequency (RF) transceiver in accordance with the present invention;

FIG. 4 is a schematic block diagram of an embodiment of a multiple band antenna structure in accordance with the present invention;

FIG. 5 is a frequency domain diagram of frequency bands in accordance with the present invention;

FIG. 6 is a diagram of an embodiment of antenna sections in accordance with the present invention;

FIG. 7 is a diagram of another embodiment of antenna sections in accordance with the present invention;

FIG. 8 is a diagram of another embodiment of antenna sections in accordance with the present invention;

FIG. 9 is a schematic block diagram of an embodiment of a multiple band antenna structure coupled to a power amplifier module and low noise amplifier module in accordance with the present invention; and

FIG. 10 is a diagram of an embodiment of a multiple band antenna structure in accordance with the present invention.

### DETAILED DESCRIPTION OF THE INVENTION

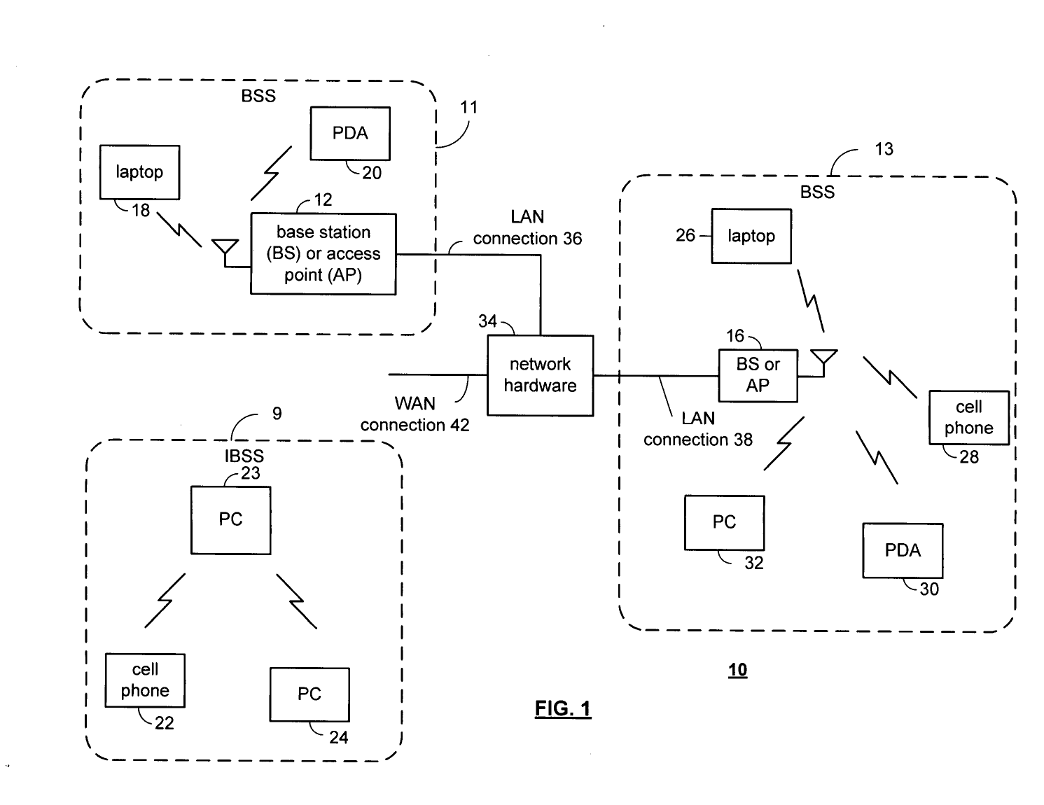

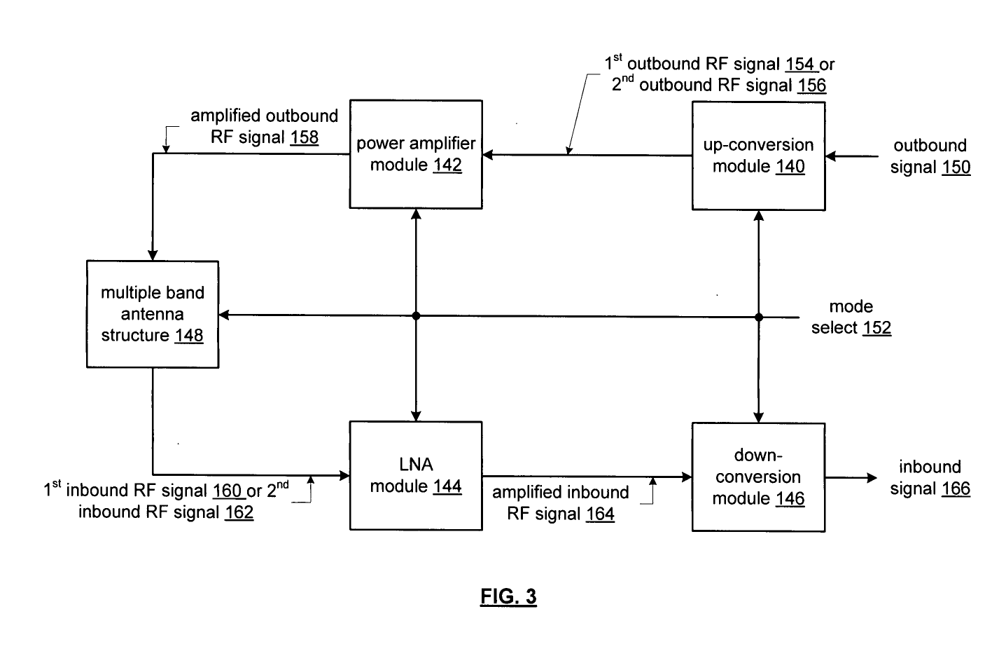

FIG. 1 is a schematic block diagram illustrating a communication system 10 that includes a plurality of base stations and/or access points 12, 16, a plurality of wireless communication devices 18-32 and a network hardware component 34. Note that the network hardware 34, which may be a router, switch, bridge, modem, system controller, et cetera provides a wide area network connection 42 for the communication system 10. Further note that the wireless communication devices 18-32 may be laptop host computers 18 and 26, personal digital assistant hosts 20 and 30, personal computer hosts 24 and 32 and/or cellular telephone hosts 22 and 28 that include a wireless transceiver. The details of the wireless transceiver will be described in greater detail with reference to FIGS. 3-10.

Wireless communication devices 22, 23, and 24 are located within an independent basic service set (IBSS) area and communicate directly (i.e., point to point). In this configuration, these devices 22, 23, and 24 may only communicate with each other. To communicate with other wireless communication devices within the system 10 or to communicate outside of the system 10, the devices 22, 23, and/or 24 need to affiliate with one of the base stations or access points 12 or 16.

The base stations or access points 12, 16 are located within basic service set (BSS) areas 11 and 13, respectively, and are operably coupled to the network hardware 34 via local area network connections 36, 38. Such a connection provides the base station or access point 12 16 with connectivity to other devices within the system 10 and provides connectivity to other networks via the WAN connection 42. To communicate with the wireless communication devices within its BSS 11 or 13, each of the base stations or access points 12-16 has an associated antenna or antenna array. For instance, base station or access point 12 wirelessly communicates with wireless communication devices 18 and 20 while base station or access point 16 wirelessly communicates with wireless communication devices 26-32. Typically, the wireless communication devices register with a particular base station or access point 12, 16 to receive services from the communication system 10.

Typically, base stations are used for cellular telephone systems and like-type systems, while access points are used for in-home or in-building wireless networks (e.g., IEEE 802.11 and versions thereof, Bluetooth, RFID, and/or any other type of radio frequency based network protocol). Regardless of the particular type of communication system, each wireless communication device includes a built-in radio and/or is coupled to a radio. Note that one or more of the wireless communication devices may include an RFID reader and/or an RFID tag.

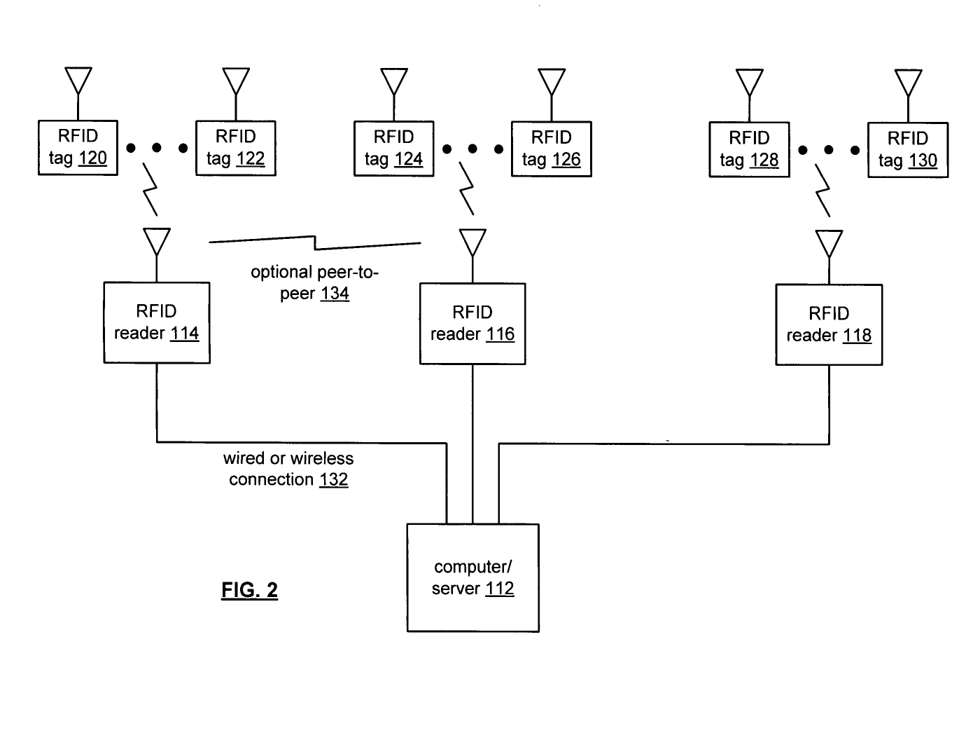

FIG. 2 is a schematic block diagram of an RFID (radio frequency identification) system that includes a computer/server 112, a plurality of RFID readers 114-118 and a plurality of RFID tags 120-130. The RFID tags 120-130 may each be associated with a particular object for a variety of purposes including, but not limited to, tracking inventory, tracking status, location determination, assembly progress, et cetera.

Each RFID reader 114-118 wirelessly communicates with one or more RFID tags 120-130 within its coverage area. For example, RFID reader 114 may have RFID tags 120 and 122 within its coverage area, while RFID reader 116 has RFID tags 124 and 126, and RFID reader 118 has RFID tags 128 and 130 within its coverage area. The RF communication scheme between the RFID readers 114-118 and RFID tags 120-130 may be a backscattering technique whereby the RFID readers 114-118 provide energy to the RFID tags via an RF signal. The RFID tags derive power from the RF signal and respond on the same RF carrier frequency with the requested data.

In this manner, the RFID readers 114-118 collect data as may be requested from the computer/server 112 from each of the RFID tags 120-130 within its coverage area. The collected data is then conveyed to computer/server 112 via the wired or wireless connection 132 and/or via the peer-to-peer communication 134. In addition, and/or in the alternative, the computer/server 112 may provide data to one or more of the RFID tags 120-130 via the associated RFID reader 114-118. Such downloaded information is application dependent and may vary greatly. Upon receiving the downloaded data, the RFID tag would store the data in a non-volatile memory.

As indicated above, the RFID readers 114-118 may optionally communicate on a peer-to-peer basis such that each RFID reader does not need a separate wired or wireless connection 132 to the computer/server 112. For example, RFID reader 114 and RFID reader 116 may communicate on a peer-to-peer basis utilizing a back scatter technique, a wireless LAN technique, and/or any other wireless communication technique. In this instance, RFID reader 116 may not include a wired or wireless connection 132 to computer/server 112. Communications between RFID reader 116 and computer/server 112 are conveyed through RFID reader 114 and the wired or wireless connection 132, which may be any one of a plurality of wired standards (e.g., Ethernet, fire wire, et cetera) and/or wireless communication standards (e.g., IEEE 802.11x, Bluetooth, et cetera).

As one of ordinary skill in the art will appreciate, the RFID system of FIG. 2 may be expanded to include a multitude of RFID readers 114-118 distributed throughout a desired location (for example, a building, office site, et cetera) where the RFID tags may be associated with equipment, inventory, personnel, et cetera. Note that the computer/server 112 may be coupled to another server and/or network connection to provide wide area network coverage.

FIG. 3 is a schematic block diagram of a radio frequency (RF) transceiver that includes a power amplifier module 142, an up-conversion module 140, a down-conversion module 146, a low noise amplifier (LNA) module 144, and a multiple band antenna structure 148.

In operation, the up-conversion module 140 is coupled to convert an outbound signal 150 into a first outbound radio frequency (RF) signal 154 in a first mode of a mode selection 152 and to convert the outbound signal 150 into a second outbound RF signal 156 in a second mode of the mode selection 152. In one embodiment, the outbound signal 150 is provided by a transmit baseband processing module, which may be on-chip or off-chip with the up-conversion module 140. The outbound signal 150 is formatted in accordance with the standards supported by the device incorporating the RF transceiver. For example, the device may be compliant with one or more versions of IEEE 802.11, Bluetooth, GSM, Enhanced Data rates for GSM Evolution (EDGE), CDMA, RFID and/or variations thereof.

As another example, if the device is compliant with Wideband code division multiple access (WCDMA) and Enhanced Data rates for GSM Evolution (EDGE), the 1^{st} outbound RF signal 154 may be in accordance with the EDGE specification (e.g., 8-PSK (phase shift keying) or GMSK (Gaussian minimum shift keying) modulation and in the transmission band of 935-960 MHz) when the RF transceiver is in the 1^{st} mode. When the RF transceiver is in the 2^{nd} mode, the 2^{nd} outbound RF signal 156 may be in accordance with a third generation (3G) CDMA standard (e.g., a minimum frequency band requirement of 2×5 MHz, carrier spacing of 4.4-5.2 MHz, maximum number of voice channels on 2×5 MHz is 196 for a spreading factor of 256, a downlink frequency band of 2110-2170 MHz, QPSK modulation, etc.)

As yet another example, the device may be compliant with IEEE 802.11(a) and IEEE 802.11(b) or (g), wherein the 1^{st} outbound RF signal 154 has a carrier frequency of approximately 2.4 GHz when the transceiver is in the IEEE 802.11(b) or (g). When the transceiver is in the IEEE 802.11(a) mode, the 2^{nd} outbound RF signal 156 has a carrier frequency of approximately 5.2 GHz.

To accommodate the different modes of operation, the up-conversion module 140 includes a mixing section to mix the outbound signal 150, which may include an in-phase component and a quadrature component, with a local oscillation. For direct conversion, the local oscillation corresponds to the carrier frequency of the 1^{st} outbound RF signal 154 when the transceiver is in the first mode and corresponds to the carrier frequency of the 2^{nd} outbound RF signal 156 when the transceiver is in the second mode.

The power amplifier module 142 is coupled to amplify the first or the second outbound RF signal 154 or 156 to produce a first or second amplified outbound RF signal 158. The power amplifier module 142, which may include one or more power amplifiers, pre-amplifiers, RF filtering, and/or gain control, provides the amplified outbound RF signal 158 to the multiple band antenna structure 148.

The multiple band antenna structure 148, which will be described in greater detail with reference to FIGS. 4-10, includes a plurality of antenna sections and a coupling circuit. Each of the plurality of antenna sections is tuned to a corresponding frequency band such that, when the RF transceiver is in the first mode, the coupling circuit couples the plurality of antenna sections into a first antenna structure for transmitting the first amplified outbound RF signal 154 for receiving a first inbound RF signal 160. When the RF transceiver is in the second mode, the coupling circuit couples the plurality of antenna sections into a second antenna structure for transmitting the second amplified outbound RF signals and for receiving a second inbound RF signal 162.

The low noise amplifier module 144 is coupled to amplify the first inbound RF signal 160 or the second inbound RF signal 162 to produce an amplified inbound RF signal 164. The low noise amplifier module 144, which may include one or more low noise amplifiers, pre-amplifiers, RF filtering, and/or gain control, provides the amplified inbound RF signal 164 to the down-conversion module 146.

The down-conversion module 146 is coupled to convert the amplified inbound RF signal 164 into an inbound signal 166. In one embodiment, the inbound signal 166 is provided to a receive baseband processing module, which may be on-chip or off-chip with the down-conversion module 146. The inbound signal 166 is formatted in accordance with the standards supported by the device incorporating the RF transceiver. For example, the device may be compliant with one or more versions of IEEE 802.11, Bluetooth, GSM, Enhanced Data rates for GSM Evolution (EDGE), CDMA, RFID and/or variations thereof.

As another example, if the device is compliant with Wideband code division multiple access (WCDMA) and Enhanced Data rates for GSM Evolution (EDGE), the 1^{st} inbound RF signal 160 may be in accordance with the EDGE specification (e.g., 8-PSK (phase shift keying) or GMSK (Gaussian minimum shift keying) modulation, and an uplink transmission frequency band of 890-915 MHz,) when the RF transceiver is in the 1^{st} mode. When the RF transceiver is in the 2^{nd} mode, the 2^{nd} inbound RF signal 162 may be in accordance with a third generation (3G) CDMA standard (e.g., a minimum frequency band requirement of 2×5 MHz, carrier spacing of 4.4-5.2 MHz, maximum number of voice channels on 2×5 MHz is 196 for a spreading factor of 256, an uplink frequency band of 1920-1980 MHz, QPSK modulation, etc.).

As yet another example, the device may be compliant with IEEE 802.11(a) and IEEE 802.11(b) or (g), wherein the 1^{st} inbound RF signal 160 has a carrier frequency of approximately 2.4 GHz when the transceiver is in the IEEE 802.11(b) or (g). When the transceiver is in the IEEE 802.11(a) mode, the 2^{nd} inbound RF signal 162 has a carrier frequency of approximately 5.2 GHz.

To accommodate the different modes of operation, the down-conversion module 146 includes a mixing section to mix the amplified inbound signal 164, which may include an in-phase component and a quadrature component, with a local oscillation. For direct conversion, the local oscillation corresponds to the carrier frequency of the 1^{st} inbound RF signal 160 when the transceiver is in the first mode and corresponds to the carrier frequency of the 2^{nd} inbound RF signal 162 when the transceiver is in the second mode.

FIG. 4 is a schematic block diagram of an embodiment of a multiple band antenna structure 148 that includes a plurality of antenna sections 170-174 and a coupling circuit 178. The coupling circuit 178 couples the plurality of antenna sections 170-174 into a first antenna structure for transceiving radio frequency signals within a first radio frequency band when the mode select 152 indicates a first mode and couples the plurality of antenna sections into a second antenna structure for transceiving radio frequency signals within a second radio frequency band when the mode select 152 indicates a first mode. In a further embodiment, the coupling circuit 176 couples the plurality of antenna sections 170-174 into a third antenna structure for transceiving radio signals within a third radio frequency band when the mode select 152 indicates a third mode.

In an embodiment of the multiple band antenna structure 148, the antenna sections 170-174 includes a monopole antenna, which may be implemented as a meandering trace on a PCB, a dipole antenna, which may be implemented as a meandering trace on a PCB, a Yagi antenna, and/or a helical antenna as taught in co-pending patent application entitled PLANER HELICAL ANTENNA, having a filing date of Mar. 21, 2006 and a Ser. No. 11/386,247. In such an embodiment, the coupling circuit 176 may include a transistor to provide coupling between a first and second antenna sections of the plurality of antenna sections and/or a capacitor to provide coupling between the first and second antenna sections of the plurality of antenna sections.

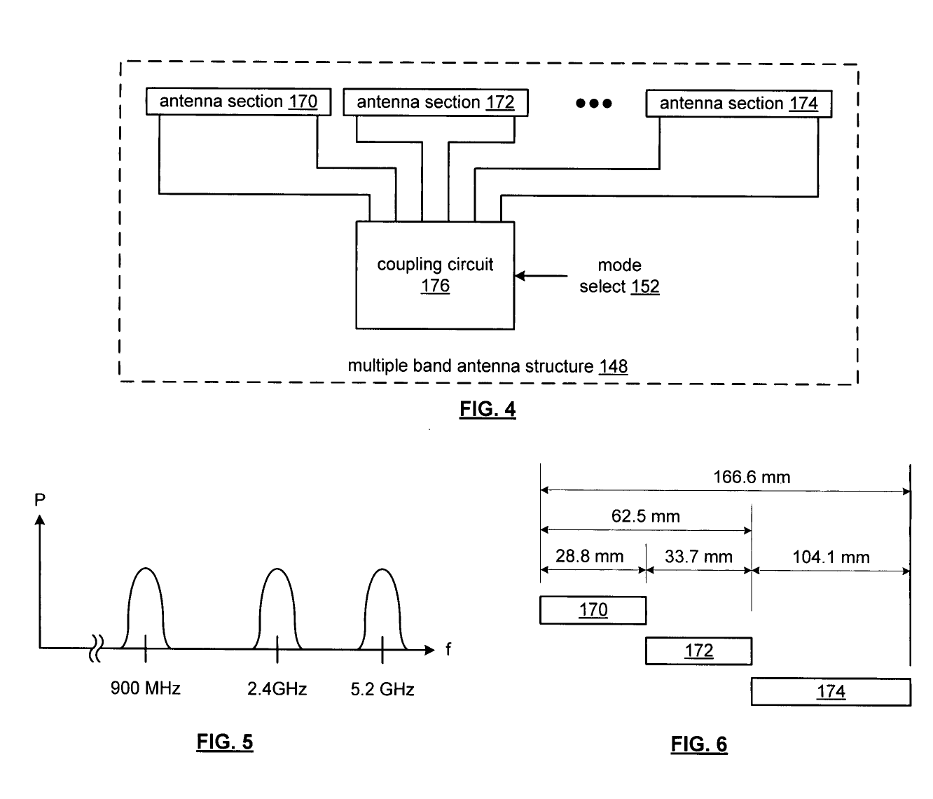

FIG. 5 is a frequency domain diagram of three frequency bands centered at 900 MHz, 2.4 GHz, and 5.2 GHz. If a multiple band antenna structure were to be made to support these three bands, the antenna sections 170-174 would need to provide the desired antenna length for the corresponding frequency bands.

FIG. 6 is a diagram of an embodiment of the antenna sections to support the frequency bands of FIG. 5. In this example, the first antenna section 170 is sized to provide a ½ wavelength (λ) dipole antenna for the 5.2 GHz operation. As is known, a 5.2 GHz signal has a wavelength of 3*10⁸/5.2*10⁹=57.7 mm and, accordingly, a ½ wavelength dipole antenna has a length of 28.8 mm. The antenna section 170 may be of a meander trace shape, a planer helical winding, etc. As such, when the RF transceiver is in a 5.2 GHz mode, the coupling circuit 176 couples the first antenna section 170 to provide the 5.2 GHz antenna structure.

For 2.4 GHz operation, the resulting 1/2λ dipole antenna structure has a total length of 62.5 mm (λ_{2.4G}=3*10⁸/2.4*10⁹=125 mm). Since the first antenna section 170 is 28.8 mm in length, the second antenna section 172 needs to be 33.7 mm in length to provide the desired overall length of 62.5 mm. The antenna section 172 may also be of a meander trace shape, a planer helical winding, etc. In this mode, the coupling circuit 176 couples the first and second antenna sections 170 and 172 together to provide a 2.4 GHz dipole antenna.

For 900 MHz operation, the resulting ½λ dipole antenna structure has a total length of 166.6 mm (λ_{900M}=3*10⁸/9*10⁸=333 mm). Since the first antenna section 170 is 28.8 mm in length and the second antenna section 172 is 33.7 mm in length, the third antenna section 174 needs to be 104.1 mm in length to provide the desired overall length of 166.6 mm. The antenna section 174 may also be of a meander trace shape, a planer helical winding, etc. In this mode, the coupling circuit 176 couples the first, second, and third antenna sections 170-174 together to provide a 900 MHz dipole antenna.

As one of ordinary skill in the art will appreciate, the number of antenna sections may vary depending on the desired number of antenna structures to support a variety of frequency bands. As one of ordinary skill in the art will further appreciate, the length of the antennas sections may be different as presented in the present example, may be of the same length, and/or of different lengths.

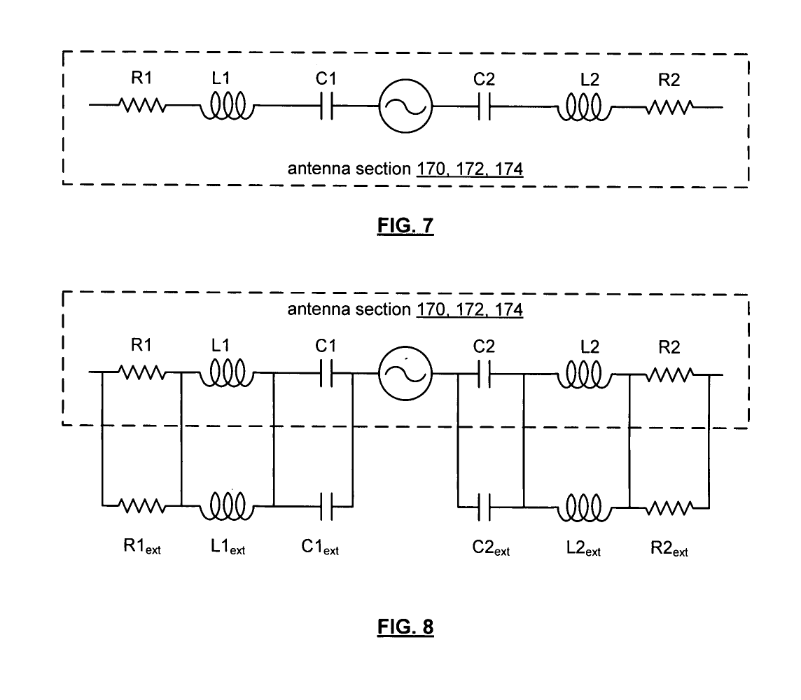

FIG. 7 is a diagram of another embodiment of antenna sections 170-174. In this embodiment, each antenna section 170-174 includes a resistive component (R1 and R2), an inductive component (L1 and L2), and a capacitive component (C1 and C2). By varying the inherent characteristics (R, L, and/or C) of an antenna, the quality factor the antenna may be tuned, the bandwidth of the antenna may be tuned, and/or the impedance of the antenna may be tuned.

FIG. 8 is a diagram of another embodiment of antenna sections 170-174. In this embodiment, each antenna section 170-174 includes a resistive component (R1 and R2), an inductive component (L1 and L2), a capacitive component (C1 and C2) and externally coupled resistive component (R1ₑₓₜ and R2ₑₓₜ), inductive component (L1ₑₓₜ and L2ₑₓₜ), and/or capacitive component (C1ₑₓₜ and C2ₑₓₜ). By varying the externally coupled components of an antenna, the quality factor the antenna may be tuned, the bandwidth of the antenna may be tuned, and/or the impedance of the antenna may be tuned.

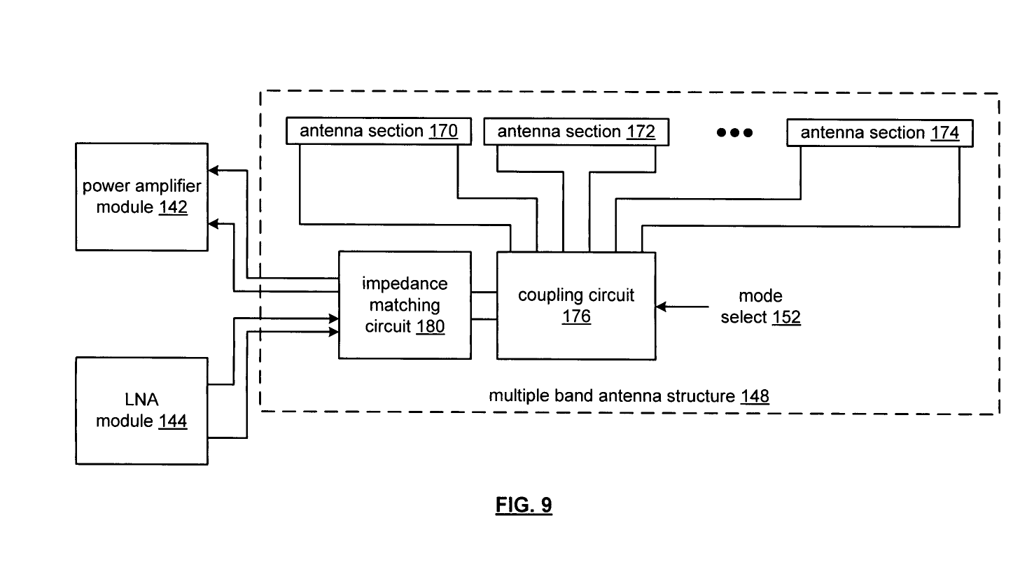

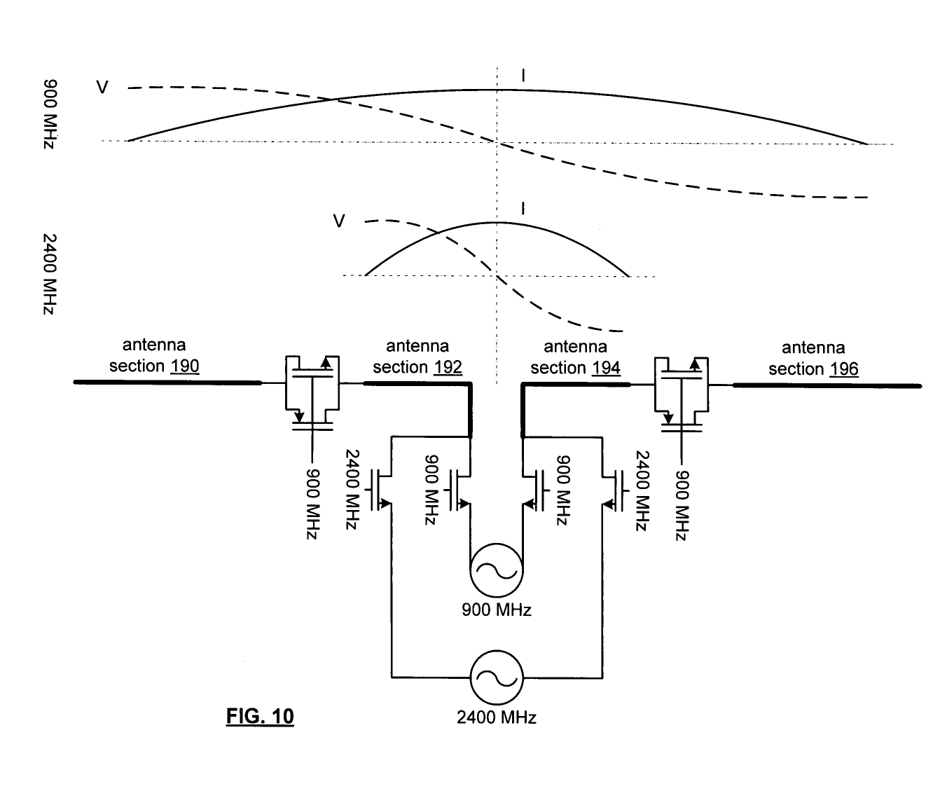

FIG. 9 is a schematic block diagram of an embodiment of a multiple band antenna structure 148 coupled to the power amplifier module 142 and the low noise amplifier module 144. In this embodiment, the multiple band antenna structure 148 includes a plurality of antenna sections 170-174, a coupling circuit 178, and an impedance matching circuit 180. The coupling circuit 178 couples the plurality of antenna sections 170-174 into a first antenna structure for transceiving radio frequency signals within a first radio frequency band when the mode select 152 indicates a first mode and couples the plurality of antenna sections into a second antenna structure for transceiving radio frequency signals within a second radio frequency band when the mode select 152 indicates a first mode. In a further embodiment, the coupling circuit 176 couples the plurality of antenna sections 170-174 into a third antenna structure for transceiving radio signals within a third radio frequency band when the mode select 152 indicates a third mode. The impedance matching circuit 180 may include one or more of a transformer balun, an inductor, a capacitor, and a resistor to substantially match the output impedance of the power amplifier module 142 and the input impedance of the LNA module 144 with the impedance of the antenna structure 148 at the desired operating frequency band.

FIG. 10 is a diagram of an embodiment of a multiple band antenna structure 148 that includes a plurality of antenna sections 190-196 and a coupling circuit that includes a plurality of transistors. In this example, the antenna structure 148 supports a 900 MHz frequency band a 2400 MHz frequency band. Antenna sections 192 and 194 are sized to provide a dipole antenna for the 2400 MHz mode of operation and antenna sections 190 and 196 are sized in combination with antenna sections 192 and 194 to provide a dipole antenna for the 900 MHz mode of operation.

When in the 900 MHz mode of operation, a 900 MHz signal generator (e.g., the output of the power amplifier module 142) is coupled via transistors to antenna sections 192 and 194. Antenna section 190 is coupled to antenna section 192 via a bidirectional transistor switch and antenna section 194 is coupled to antenna section 194 via another bidirectional transistor switch. In this configuration, the multiple band antenna structure 148 is configured to provide a 900 MHz dipole antenna, which produces standing voltage and current waveforms as shown.

When in the 2400 MHz mode of operation, a 2400 MHz signal generator (e.g., the output of the power amplifier module 142) is coupled via transistors to antenna sections 192 and 194. Antenna section 190 is not coupled to antenna section 192 via a bidirectional transistor switch and antenna section 194 is not coupled to antenna section 194 via another bidirectional transistor switch. In this configuration, the multiple band antenna structure 148 is configured to provide a 2400 MHz dipole antenna, which produces standing voltage and current waveforms as shown.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A multiple band antenna structure comprises:
a plurality of antenna sections, wherein each of the plurality of antenna sections is tuned to a corresponding frequency band; and
a coupling circuit operable in a first mode to couple the plurality of antenna sections into a first antenna structure for transceiving radio frequency signals within a first radio frequency band and operable in a second mode to couple the plurality of antenna sections into a second antenna structure for transceiving radio frequency signals within a second radio frequency band.

2. The multiple band antenna structure of claim 1, wherein the coupling circuit is further operable in a third mode to couple the plurality of antenna sections into a third antenna structure for transceiving radio signals within a third radio frequency band.

3. The multiple band antenna structure of claim 1, wherein each of the plurality of antenna sections comprises:
an antenna having a resistive component, an inductive component, and a capacitive component, wherein the resistive component, the inductive component, and the capacitive component have a value to provide a resonant frequency at the corresponding frequency band.

4. The multiple band antenna structure of claim 3, wherein each of the plurality of antenna sections comprises at least one of:
a monopole antenna;
a dipole antenna;
a Yagi antenna; and
a helical antenna.

5. The multiple band antenna structure of claim 3, wherein each of the plurality of antenna sections further comprises at least one of:
a resistor coupled to the antenna to provide, in combination with the resistive component of the antenna, a resistance of the each of the plurality of antenna sections;
a capacitor to the antenna to provide, in combination with the capacitive component of the antenna, a capacitance of the each of the plurality of antenna sections; and
an inductor to the antenna to provide, in combination with the inductive component of the antenna, an inductance of the each of the plurality of antenna sections, wherein at least one of the resistor, the capacitor, and the inductor, in combination with, the resistive component, the inductive component, and the capacitive component provide the resonant frequency at the corresponding frequency band.

6. The multiple band antenna structure of claim 1, wherein the coupling circuit comprises at least one of:
a transistor to provide coupling between a first and second antenna sections of the plurality of antenna sections; and
a capacitor to provide coupling between the first and second antenna sections of the plurality of antenna sections.

7. The multiple band antenna structure of claim 1 further comprises:
an impedance matching circuit operable in the first mode to provide a first impedance corresponding to the first antenna structure and operable in the second mode to provide a second impedance corresponding to the second antenna structure.

8. A multiple band antenna structure comprises:
a first antenna section tuned to a first frequency band;
a second antenna section tuned to a second frequency band; and
a coupling circuit operable in a first mode to couple the first and second antenna sections into a first antenna structure for transceiving radio frequency signals within a first radio frequency band and operable in a second mode to couple the first and second antenna sections into a second antenna structure for transceiving radio frequency signals within a second radio frequency band.

9. The multiple band antenna structure of claim 8 further comprises:
a third antenna section tuned to a third frequency band, wherein the coupling circuit is further operable in a third mode to couple the first, second, and third antenna sections into a third antenna structure for transceiving radio signals within a third radio frequency band.

10. The multiple band antenna structure of claim 8, wherein each of the first and second antenna sections comprises:
an antenna having a resistive component, an inductive component, and a capacitive component, wherein the resistive component, the inductive component, and the capacitive component have a value to provide a resonant frequency at the corresponding frequency band.

11. The multiple band antenna structure of claim 10, wherein each of the first and second antenna sections comprises at least one of:
a monopole antenna;
a dipole antenna;
a Yagi antenna; and
a helical antenna.

12. The multiple band antenna structure of claim 10, wherein each of the first and second antenna sections further comprises at least one of:
a resistor coupled to the antenna to provide, in combination with the resistive component of the antenna, a resistance of the each of the plurality of antenna sections;
a capacitor to the antenna to provide, in combination with the capacitive component of the antenna, a capacitance of the each of the plurality of antenna sections; and
an inductor to the antenna to provide, in combination with the inductive component of the antenna, an inductance of the each of the plurality of antenna sections, wherein at least one of the resistor, the capacitor, and the inductor, in combination with, the resistive component, the inductive component, and the capacitive component provide the resonant frequency at the corresponding frequency band.

13. The multiple band antenna structure of claim 8, wherein the coupling circuit comprises at least one of:
a transistor to provide coupling between a first and second antenna sections of the plurality of antenna sections; and
a capacitor to provide coupling between the first and second antenna sections of the plurality of antenna sections.

14. The multiple band antenna structure of claim 8 further comprises:
an impedance matching circuit operable in the first mode to provide a first impedance corresponding to the first antenna structure and operable in the second mode to provide a second impedance corresponding to the second antenna structure.

15. A radio frequency transceiver comprises:
an up-conversion module coupled to convert an outbound signal into a first outbound radio frequency (RF) signal in a first mode and to convert the outbound signal into a second outbound RF signal in a second mode;
a power amplifier module coupled to amplify the first or the second outbound RF signal to produce a first amplified outbound RF signal or a second amplified inbound RF signal;
a low noise amplifier module coupled to amplify a first inbound RF signal or a second inbound RF signal to produce an amplified inbound RF signal;
a down-conversion module coupled to convert the amplified inbound RF signal into an inbound signal; and
a multiple band antenna structure that includes:
a plurality of antenna sections, wherein each of the plurality of antenna sections is tuned to a corresponding frequency band; and
a coupling circuit operable in the first mode to couple the plurality of antenna sections into a first antenna structure for transceiving the first inbound and amplified outbound RF signals and operable in the second mode to couple the plurality of antenna sections into a second antenna structure for transceiving the second inbound and amplified outbound RF signals.

16. The radio frequency transceiver of claim 15, wherein the coupling circuit is further operable in a third mode to couple the plurality of antenna sections into a third antenna structure for transceiving radio signals within a third radio frequency band.

17. The radio frequency transceiver of claim 15, wherein each of the plurality of antenna sections comprises:
an antenna having a resistive component, an inductive component, and a capacitive component, wherein the resistive component, the inductive component, and the capacitive component have a value to provide a resonant frequency at the corresponding frequency band.

18. The radio frequency transceiver of claim 17, wherein each of the plurality of antenna sections comprises at least one of:
a monopole antenna;
a dipole antenna;
a Yagi antenna; and
a helical antenna.

19. The radio frequency transceiver of claim 17, wherein each of the plurality of antenna sections further comprises at least one of:
a resistor coupled to the antenna to provide, in combination with the resistive component of the antenna, a resistance of the each of the plurality of antenna sections;
a capacitor to the antenna to provide, in combination with the capacitive component of the antenna, a capacitance of the each of the plurality of antenna sections; and
an inductor to the antenna to provide, in combination with the inductive component of the antenna, an inductance of the each of the plurality of antenna sections, wherein at least one of the resistor, the capacitor, and the inductor, in combination with, the resistive component, the inductive component, and the capacitive component provide the resonant frequency at the corresponding frequency band.

20. The radio frequency transceiver of claim 15, wherein the coupling circuit comprises at least one of:
a transistor to provide coupling between a first and second antenna sections of the plurality of antenna sections; and
a capacitor to provide coupling between the first and second antenna sections of the plurality of antenna sections.

21. The radio frequency transceiver of claim 15 further comprises:
an impedance matching circuit operable in the first mode to provide a first impedance corresponding to the first antenna structure and operable in the second mode to provide a second impedance corresponding to the second antenna structure.
